(19) United States
(12) Patent Application Publication
(10) Pub. No.: US 2010/0052340 A1
(43) Pub. Date: Mar. 4, 2010

(54) DOOR RESTRAINING DEVICE

(76) Inventor: James R. Thomas, Dallas, GA (US)

Correspondence Address: MORRIS MANNING MARTIN LLP, 3343 PEACHTREE ROAD, NE, 1600 ATLANTA FINANCIAL CENTER, ATLANTA, GA, 30326, US

(21) Appl. No.: 12/552,366

(22) Filed: Sep. 2, 2009

Related U.S. Application Data
(60) Provisional application No. 61/093,971, filed on Sep. 3, 2008.

(51) Int. Cl. E05C 19/18; E05C 19/00

(52) U.S. Cl. 292/297; 292/304

(57) ABSTRACT

In one aspect, the present invention relates to a door restraining device. In one embodiment, the door restraining device includes a base portion having a first end and an opposite, second end defining therebetween a base body having a base length and extending along a first direction, a first wall portion extending away from the first end of the base portion along a second direction that is different from the first direction, a second wall portion extending away from the second end of the base portion along a third direction that is different from the first direction, and, a rotatable arm portion rotatably connected at its first end to the first wall portion at a fixed rotation point.

### CROSS-REFERENCE TO RELATED PATENT APPLICATION

This application claims priority to and the benefit of, pursuant to 35 U.S.C. §119(e), of U.S. provisional Application Ser. No. 61/093,971, filed Sep. 3, 2008 entitled “Rotatable Door Stopper” by James E. Thomas, the disclosure for which is hereby incorporated herein in its entirety by reference.

Some references, if any, which may include patents, patent applications and various publications, are cited and discussed in the description of this invention. The citation and/or discussion of such references is provided merely to clarify the description of the present invention and is not an admission that any such reference is “prior art” to the invention described herein. All references cited and discussed in this specification are incorporated herein by reference in their entireties and to the same extent as if each reference was individually incorporated by reference.

### FIELD OF THE INVENTION

The present invention is generally related to a door restraining device.

### BACKGROUND OF THE INVENTION

A door can be held in a desired position for several purposes, such as to provide natural ventilation in a home or commercial building, or to provide easy access for a person to pass in and out of the doorway without being required to manually open and close the door each time. Often, random objects are used in attempt to restrain the door in the desired position. For example, heavy objects such as rocks or bricks may be pushed against the door or wedged between the base of the door and the floor surface beneath. However, these implements often prove ineffective, as they are prone to slide across the floor surface from the closing force provided by the door hinge or spring. In addition, these objects can be cumbersome and visually unattractive or may cause damage to the door, door frame, or hinges. In commercial settings where high speed airflow such as gusts of wind are common, if the door is inadequately restrained it may violently swing open or closed. This can pose great danger to anyone near the door area.

Therefore, a heretofore unaddressed need still exists in the art to address the aforementioned deficiencies and inadequacies.

### SUMMARY OF THE INVENTION

The present invention, in one aspect, relates to a door restraining device. In one embodiment, the door restraining device includes a base portion having a first end and an opposite, second end, which defines a base body between the first end and second end, having a base length, L₀, and extending along a first direction, a first wall portion extending away from the first end of the base portion along a second direction that is different from the first direction, a second wall portion extending away from the second end of the base portion along a third direction that is different from the first direction, and, a rotatable arm portion rotatably connected at its first end to the first wall portion at a fixed rotation point. The first wall portion and the second wall portion are substantially parallel to each other, such that the second direction and the third direction is substantially one direction, and the base portion is substantially perpendicular to both the first wall portion and the second wall portion such that the one direction is substantially perpendicular to the first direction. The first wall portion has a height, H₁, and the second wall portion has a height, H₂, such that H₂>H₁.

In one embodiment, the rotatable arm portion is rotatable about the fixed rotation point between a first position in which the door is unrestrained from movement and a second position in which the door is restrained from movement. The length of the base body, L₀, the height of the first wall portion, H₁, and the height of the second wall portion, H₂ are selected such that in operation, when the rotatable arm portion is in the second position, the door is secured between the rotatable arm portion and the second wall portion. The base body is substantially flat, and anchoring means anchor the base portion to a mounting surface. A plurality of spaced holes are formed in the base body of the base portion, where each of the spaced holes is capable of receiving a corresponding one of the anchoring means. A first resilient member is attached to the rotatable arm portion at a second end opposite to the first end, and a second resilient member is attached to the second wall portion. The range of angular rotation of the rotatable arm portion, α, is such that 0≦α≦π, where the first position of the rotatable arm corresponds to an angle of rotation, α₁, of about 0 and the second position corresponds to an angle of rotation, α₂, of about π/2. The height of the first wall portion, H₁, and the height of the second wall portion, H₂, are selected such that H₁<H_{D}<H₂, where H_{D} is a separation distance between a mounting surface for receiving the base portion and a base of the door. An extension portion is defined between the first end and opposite second end of the rotatable arm portion, which is capable of receiving means for rotating the rotatable arm portion.

In another aspect, the present invention relates to a door restraining means for selectively restraining a door. In one embodiment, the door restraining means includes a base portion for receiving anchoring means to anchor the door restraining means onto a mounting surface, and a rotatable arm portion rotatably connected to the base portion, for rotating between a first position in which the door is unrestrained from movement and a second position in which the door is restrained from movement.

In yet another aspect, the present invention relates to a method for selectively restraining a door. In one embodiment, the method has the steps of providing a door restraining means that includes a base portion having a first end and an opposite, second end defining a base body between the first end and second end, and having a base length, L₀, which extends along a first direction. The method also has the steps of providing a first wall portion extending away from the first end of the base portion along a second direction that is different from the first direction, providing a second wall portion extending away from the second end of the base portion along a third direction that is different from the first direction, and providing a rotatable arm portion rotatably connected at its first end to the first wall portion at a fixed rotation point. The method further has the steps of positioning the door restraining means onto a location of a mounting surface corresponding to a desired location for restraining the door into a secured position and anchoring the door restraining means onto the mounting surface at the desired location.

In one embodiment, the method for selectively restraining a door also has the step of moving the door to the desired location, such that the base of the door is substantially covering the base body, and rotating the rotatable arm portion about the fixed rotation point from a first position in which the door is unrestrained from movement, to a second position in which the door is restrained from movement, such that the door is secured between the rotatable arm portion and the second wall portion. The method further has the step of providing the first wall portion and the second wall portion such as to be substantially parallel to each other, and such that the second direction and the third direction are substantially one direction. The base portion is provided such as to be substantially perpendicular to both the first wall portion and the second wall portion, and such that the one direction is substantially perpendicular to the first direction. Also, the first wall portion is provided such that it has a height, H₁, and the second wall portion has a height, H₂, such that H₂>H₁. Also, the method has the steps of rotating the rotatable arm portion about the fixed rotation point 132 from the second position to the first position. In one embodiment the method further has the steps of providing an extension portion defined between the first end of the rotatable arm portion and an opposite, second end, for receiving a force to rotate the rotatable arm portion, and, rotating the rotatable arm portion by engaging the extension portion. The method also has the step of selecting the height of the first wall portion, H₁, and the height of the second wall portion, H₂, such that H₁<H_{D}<H₂, where H_{D} is the separation distance between the flat mounting surface and a base of the door.

These and other aspects of the present invention will become apparent from the following description of the preferred embodiments, taken in conjunction with the following drawings, although variations and modifications therein may be affected without departing from the spirit and scope of the novel concepts of the disclosure.

### BRIEF DESCRIPTION OF THE DRAWINGS

The accompanying drawings illustrate one or more embodiments of the invention and, together with the written description, serve to explain the principles of the invention. Wherever possible, the same reference numbers are used throughout the drawings to refer to the same or like elements of an embodiment, and wherein:

FIG. 1 shows schematically a perspective view of a door restraining device according to one embodiment of the present invention, in a first position;

FIG. 2 shows schematically a front elevational view of a door restraining device according to the embodiment shown in FIG. 1;

FIG. 3 shows schematically a left side elevational view of a door restraining device according to the embodiment shown in FIG. 1;

FIG. 4 shows schematically a top plan view of a door restraining device according to the embodiment shown in FIG. 1;

FIG. 5 shows schematically a perspective view of a door restraining device according to the embodiment shown in FIG. 1, in a second position;

FIG. 6 shows schematically another perspective view of a door restraining device in the first state, according to the embodiment shown in FIG. 1;

FIG. 7 shows schematically a perspective view of a door restraining device according to another embodiment of the present invention, in the first position;

FIG. 8 shows schematically another perspective view a door restraining device according to the embodiment shown in FIG. 7;

FIG. 9 shows schematically yet another perspective view of a door restraining device according to the embodiment shown in FIG. 7;

FIG. 10 schematically shows a door restrained by a door restraining device according to one embodiment of the present invention; and

FIG. 11 schematically shows a door restrained by a door restraining device according to another embodiment of the present invention.

### DETAILED DESCRIPTION OF THE INVENTION

The present invention is more particularly described in the following examples that are intended as illustrative only since numerous modifications and variations therein will be apparent to those skilled in the art. Various embodiments of the invention are now described in detail. Referring to the drawings, like numbers indicate like components throughout the views. As used in the description herein and throughout the claims that follow, the meaning of “a”, “an”, and “the” includes plural reference unless the context clearly dictates otherwise. Also, as used in the description herein and throughout the claims that follow, the meaning of “in” includes “in” and “on” unless the context clearly dictates otherwise.

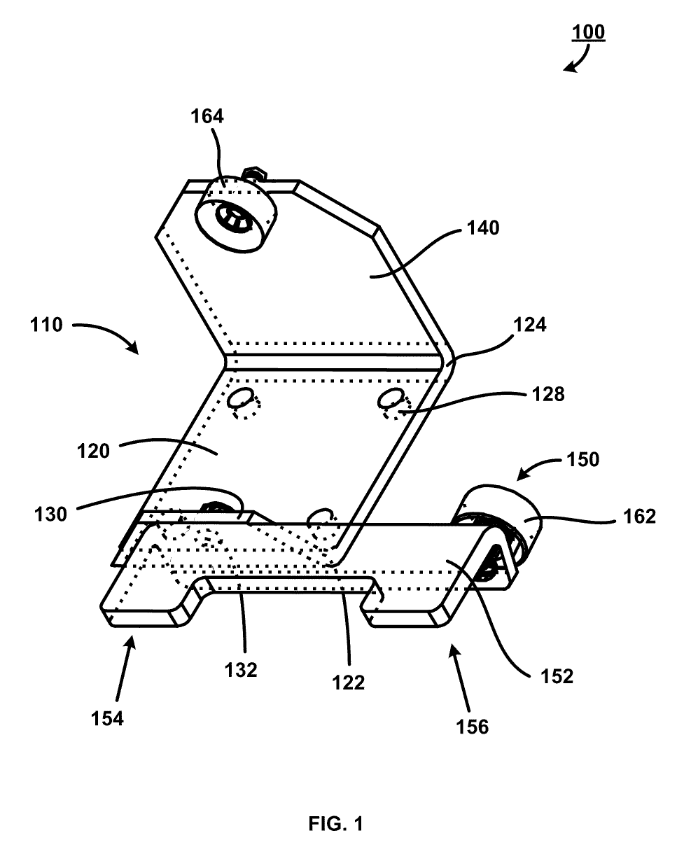

The description will be made as to the embodiments of the present invention in conjunction with the accompanying drawings in FIGS. 1-11.

Now referring to FIG. 1, a door restraining device 100 according to one embodiment of the present invention is shown, which includes a base portion 110 having a first end 122 and an opposite, second end 124, defining a base body 120 between the first end 122 and second end 124, which has a base length, L₀ and extends along a first direction. A first wall portion 130 extends away from the first end of the base portion 122 along a second direction that is different from the first direction, a second wall portion 140 extends away from the second end of the base portion 124 along a third direction that is different from the first direction, and, a rotatable arm portion 150 is rotatably connected at its first end 154 to the first wall portion 130 at a fixed rotation point 132. As shown, the first wall portion 130 and the second wall portion 140 are substantially parallel to each other, such that the second direction and the third direction is substantially one direction. In addition, the base portion 110 is substantially perpendicular to both the first wall portion 130 and the second wall portion 140 such that the one direction is substantially perpendicular to the first direction. The first wall portion 130 has a height, H₁, and the second wall portion 140 has a height, H₂, such that H₂>H₁.

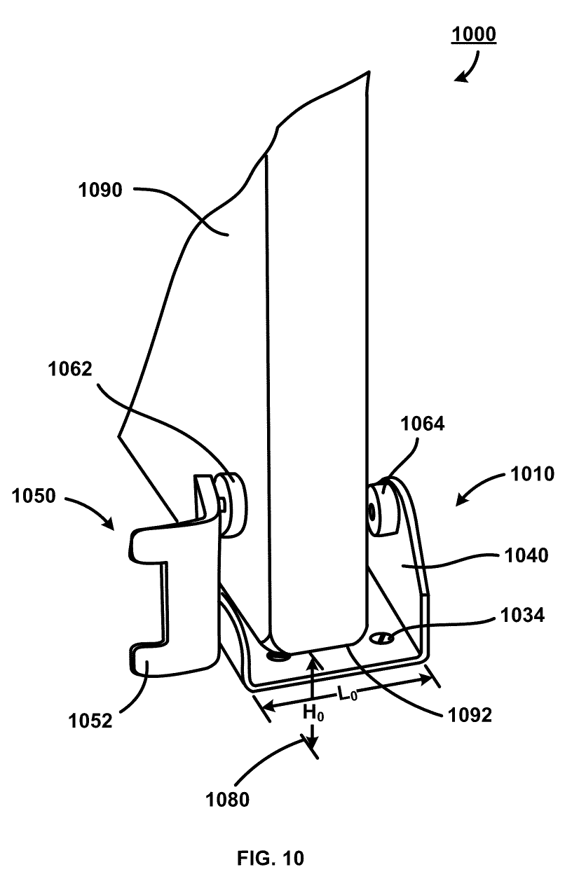

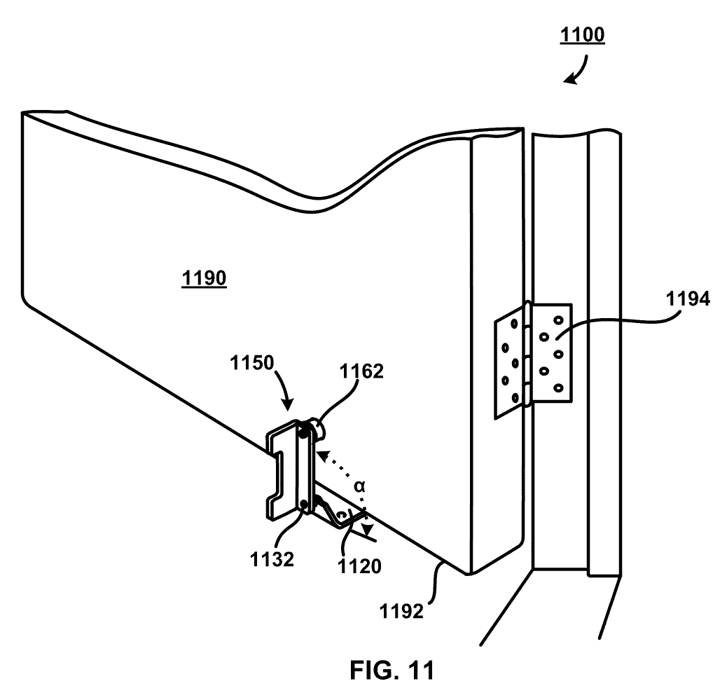

Now referring to FIGS. 1, 10 and 11, the rotatable arm portion 150 is rotatable about the fixed rotation point 132 between a first position, shown in FIG. 1, where a door is unrestrained from movement, and a second position, shown in FIG. 10, in which the door 1090, is restrained from movement. The length of the base body, L₀, the height of the first wall portion, H₁, and the height of the second wall portion, H₂ are selected such that in operation, when the rotatable arm portion 150 is in the second position, the door 1090 is secured between the rotatable arm portion 150 and the second wall portion 140. The base body 120 is substantially flat, and an anchoring means 1034 anchors the base portion 110 to a mounting surface 1080. Depending upon the desired location for the door restraining device 100 and the type of mounting surface 1080 on which the device 100 is to be anchored, the anchoring means 1034 can be lag screws, wedge anchors, sleeve anchors, epoxy, or drive pins, for example. A plurality of spaced holes 128 are formed in the base body 120 of the base portion 110, each capable of receiving a corresponding one of the anchoring means 1034. As shown, a first resilient member 162 is attached to the rotatable arm portion 150 at a second end 156 opposite to the first end 154, and a second resilient member 164 is attached to the second wall portion 140. These can be formed of rubber, plastic, or another resilient material. As shown in FIG. 11, the range of angular rotation of the rotatable arm portion, α, is such that 0≦α≦π, where the first position of the rotatable arm corresponds to an angle of rotation, α₁, of about 0 and the second position (shown) corresponds to an angle of rotation, α₂, of about π/2. Again with reference to FIG. 10, the height of the first wall portion, H₁, and the height of the second wall portion, H₂, are selected such that H₁<H_{D}<H₂, where H_{D} is a separation distance between a mounting surface 1080 for receiving the base portion 110 and a base of the door 1090. As an example, the separation distance H_{D} is between about ¾ inches and 2¾ inches for most doors.

In one intended method of use of the door restraining device 100, the door 1090 is moved from an initial position (e.g. completely closed) along its normal range of motion such that the base of the door 1092 passes over the first wall portion 130 and rotatable arm portion 150 until the base of the door 1092 is substantially covering the base body 120 and a leading surface of the door 1090 is contacting the resilient member 164. The rotatable arm portion 150 is then moved along its range of angular rotation α into a position (e.g. α=π/2) in which the first resilient member 162 is in direct contact with the opposite surface of the door or otherwise the door 1090 is prevented from returning to its initial position, meaning that the door is effectively restrained between the first resilient member 162 on the rotatable arm portion 150 and the second resilient member 164 on the second wall portion 140. An extension portion 152 is defined between the first end 154 and opposite second end 156 of the rotatable arm portion 150, which is capable of receiving means for rotating the rotatable arm portion 150. The means for rotating the arm portion can be, for instance, a human foot pushed under the extension portion 152 such that when the person lifts up their foot, the rotatable arm portion 150 moves from the first position to the second position.

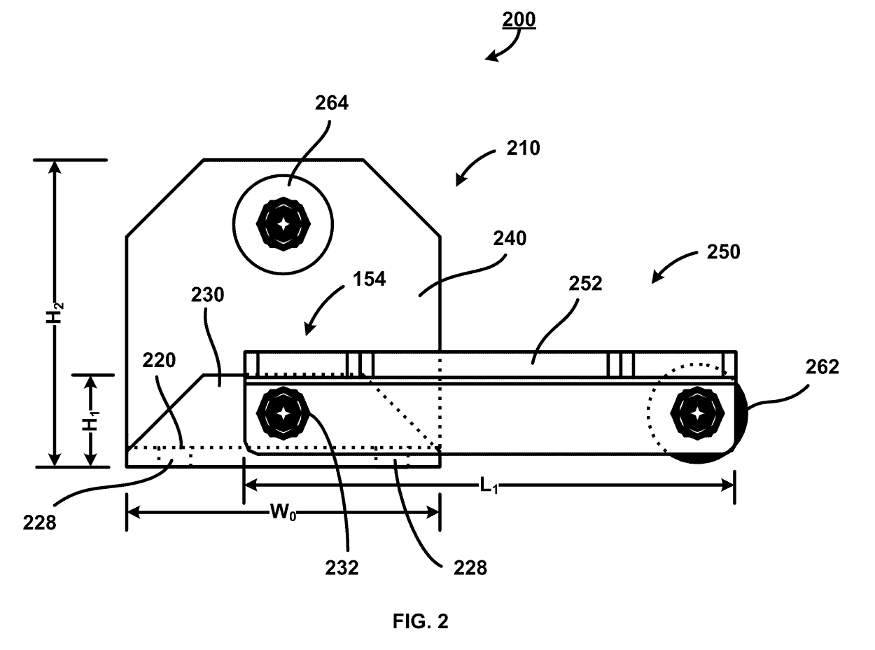

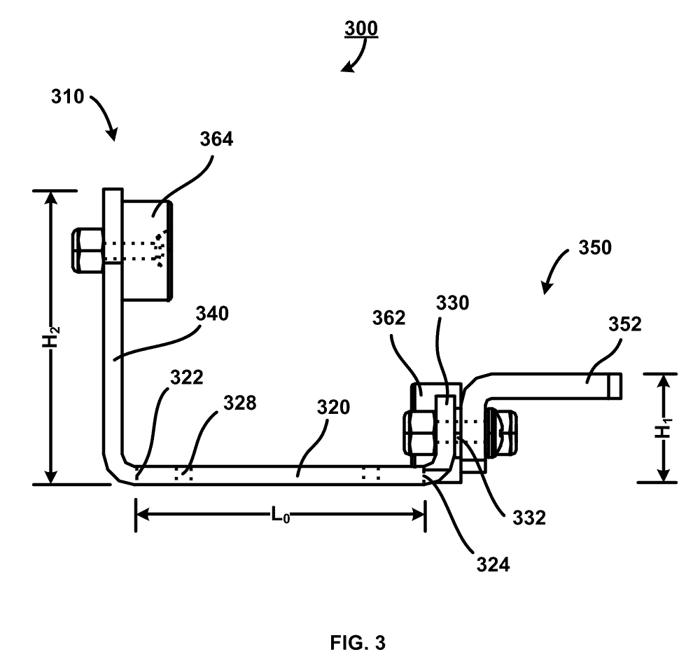

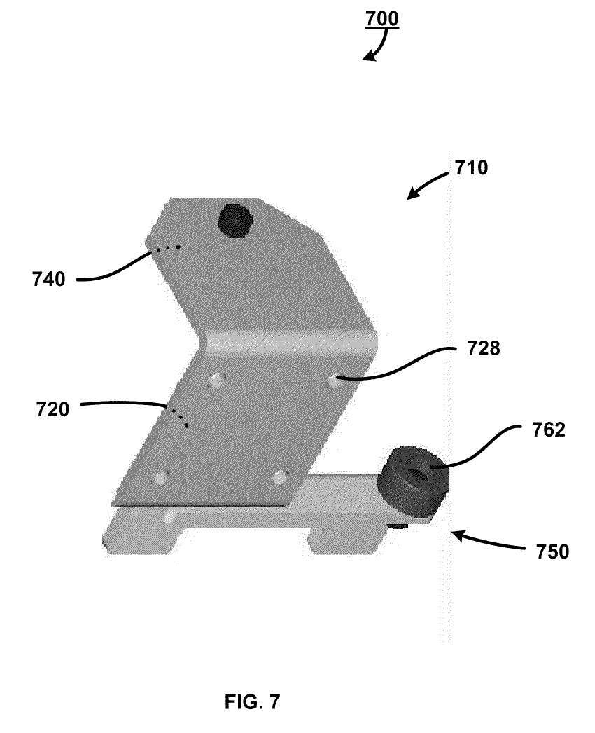

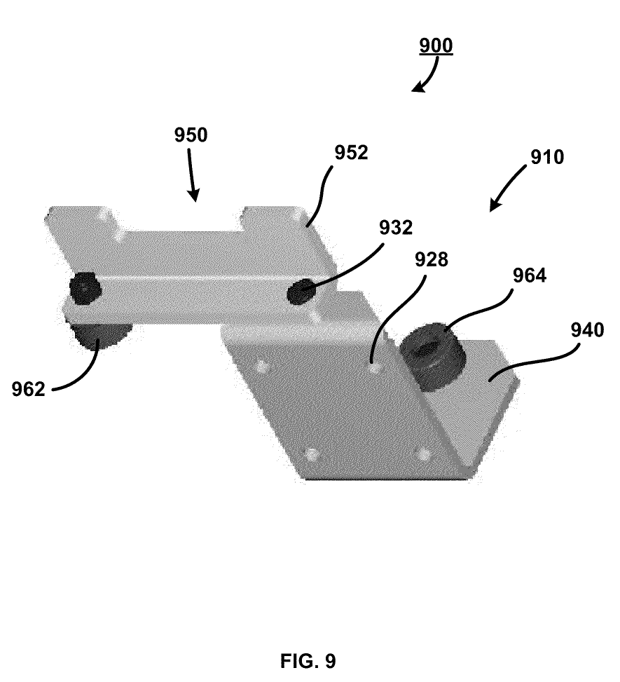

FIG. 2 shows a front elevational view of a door restraining device 200 according to the embodiment shown in FIG. 1. As also shown in the embodiments of FIGS. 3-6 and 11, the rotatable arm portion 250 in the embodiment shown in FIG. 2 is a right-handed component. In other words, when in the first position corresponding to an angular position of α=0, the rotatable arm portion 250 extends horizontally to the right in relation to the fixed rotation point 232, when viewed from the front. In contrast, in the embodiments shown in FIGS. 7-10, the rotatable arm portion (e.g. 950, FIG. 9) is a left-handed component, meaning that when in the first position, the rotatable arm portion 950 extends horizontally to the left in relation to the fixed rotation point 932, when viewed from the front.

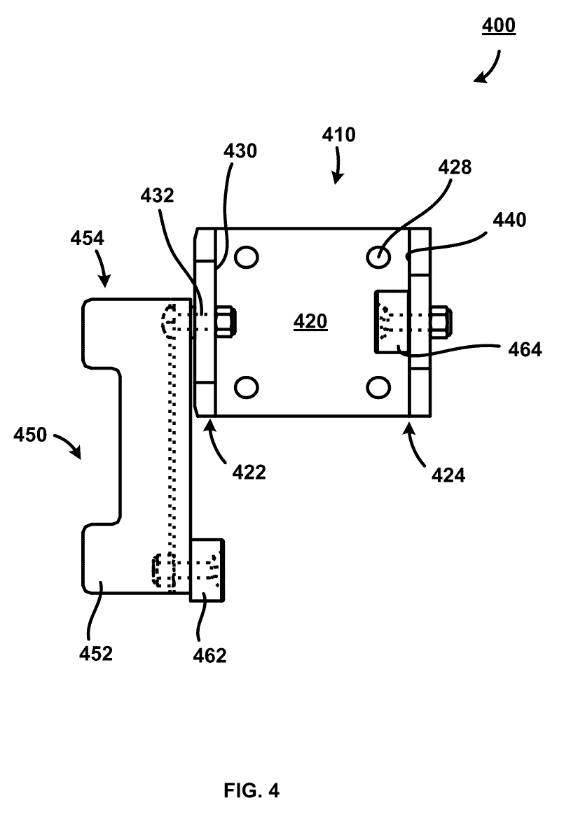

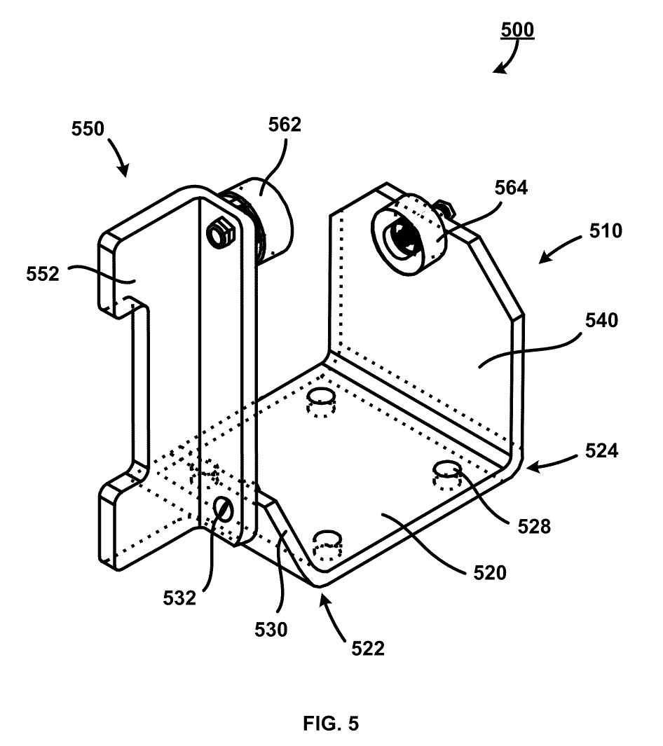

FIG. 3 shows a left side elevational view of a door restraining device 300 according to the embodiment shown in FIG. 1, and FIG. 4 shows a top plan view of a door restraining device 500 according to the embodiment shown in FIG. 1. FIG. 5 shows a perspective view of a door restraining device 500 according to the embodiment of FIG. 1, with the rotatable arm portion 550 in a second position where α=π/2.

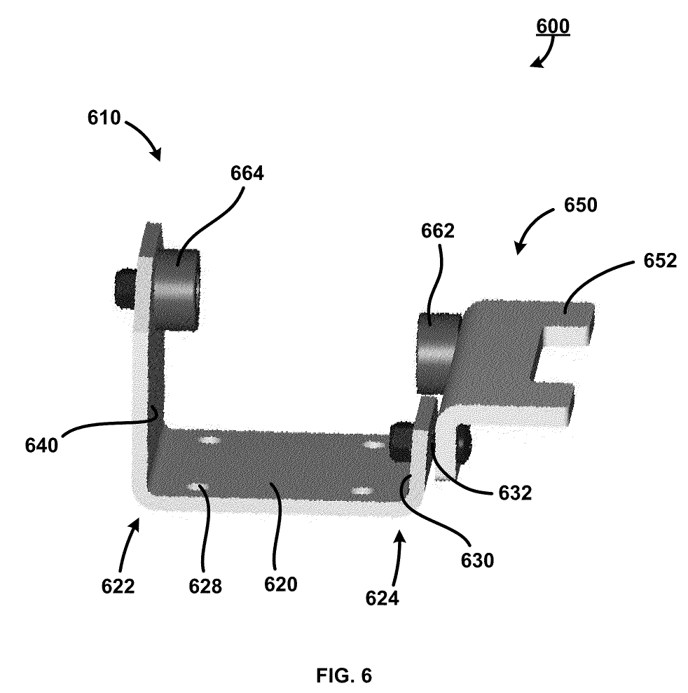

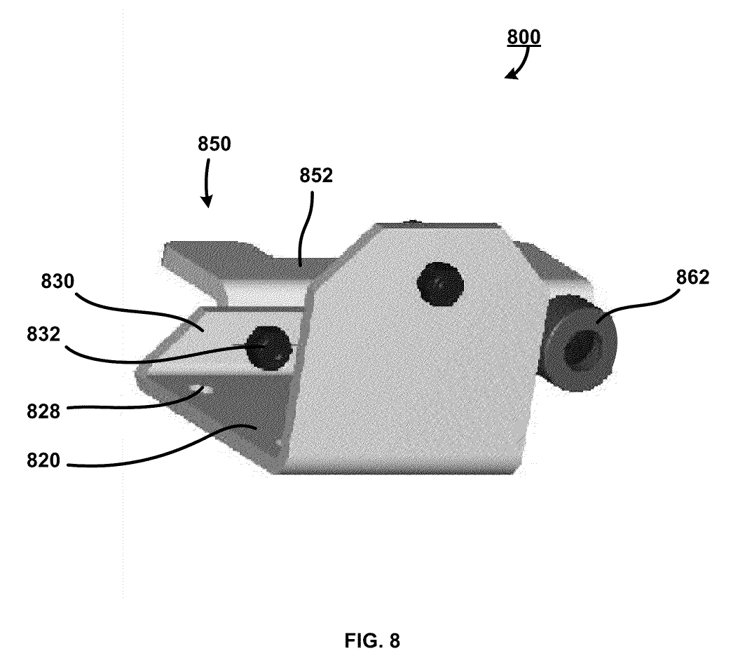

FIG. 6 shows another perspective view of a door restraining device 600 in a first position, according to the embodiment shown in FIG. 1, and FIG. 7 shows a perspective view of a door restraining device 700 in a first position, according to another embodiment of the present invention, where the rotatable arm portion 750 is a left-handed component. FIG. 8 shows another perspective view a door restraining device 800 according to the embodiment of FIG. 7. FIG. 9 shows yet another perspective view of a door restraining device 900 according to the embodiment shown in FIG. 7.

As described above in connection with FIG. 1, FIG. 10 shows a door 1090 restrained by a door restraining device 1000 according to one embodiment of the present invention, and FIG. 11 shows a door 1190 restrained by a door restraining device 1100 according to another embodiment of the present invention

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments were chosen and described in order to explain the principles of the invention and their practical application so as to activate others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. A door restraining device, comprising:
a base portion having a first end and an opposite, second end defining a base body therebetween, the base body having a base length, L₀, and extending along a first direction;
a first wall portion extending away from the first end of the base portion along a second direction that is different from the first direction;
a second wall portion extending away from the second end of the base portion along a third direction that is different from the first direction; and
a rotatable arm portion rotatably connected at its first end to the first wall portion at a fixed rotation point.

2. The door restraining device of claim 1, wherein the first wall portion and the second wall portion are substantially parallel to each other such that the second direction and the third direction is substantially one direction, wherein the base portion is substantially perpendicular to both the first wall portion and the second wall portion such that the one direction is substantially perpendicular to the first direction, and wherein the first wall portion has a height, H₁, and the second wall portion has a height, H₂, such that H₂>H₁.

3. The door restraining device of claim 1, wherein the rotatable arm portion is rotatable about the fixed rotation point between a first position in which a door is unrestrained from movement and a second position in which the door is restrained from movement.

4. The door restraining device of claim 3, wherein the length of the base body, L₀, the height of the first wall portion, H₁, and the height of the second wall portion, H₂ are selected such that in operation, when the rotatable arm portion is in the second position, the door is secured between the rotatable arm portion and the second wall portion.

5. The door restraining device of claim 1, wherein the base body is substantially flat.

6. The door restraining device of claim 1, further comprising anchoring means for anchoring the base portion to a mounting surface.

7. The door restraining device of claim 6, wherein the base portion has a plurality of spaced holes formed in the base body, each of the spaced holes being capable of receiving a corresponding one of the anchoring means.

8. The door restraining device of claim 1, further comprising a first resilient member attached to the rotatable arm portion at a second end opposite to the first end, and a second resilient member attached to the second wall portion.

9. The door restraining device of claim 8, wherein the range of angular rotation of the rotatable arm portion, α, is such that 0≦α≦π.

10. The door restraining device of claim 9, wherein the first position corresponds to an angle of rotation, α₁, of about 0 and the second position corresponds to an angle of rotation, α₂, of about π/2.

11. The door restraining device of claim 1, wherein the height of the first wall portion, H₁, and the height of the second wall portion, H₂, are selected such that H₁<H_{D}<H₂, where H_{D} is a separation distance between a mounting surface for receiving the base portion and a base of the door.

12. The door restraining device of claim 1, wherein the rotatable arm portion has an extension portion defined between its first end and an opposite, second end, capable of receiving means for rotating the rotatable arm portion.

13. A door restraining means for selectively restraining a door, comprising:
a base portion for receiving anchoring means for anchoring the door restraining means onto a mounting surface; and
a rotatable arm portion rotatably connected to the base portion for rotating between a first position, in which the door is unrestrained from movement, and a second position, in which the door is restrained from movement.

14. A method for selectively restraining a door, comprising the steps of:
providing a door restraining means, wherein the door restraining means comprises:
a base portion having a first end and an opposite, second end defining a base body therebetween, the base body having a base length, L₀ and extending along a first direction;
a first wall portion extending away from the first end of the base portion along a second direction that is different from the first direction;
a second wall portion extending away from the second end of the base portion along a third direction that is different from the first direction; and
a rotatable arm portion rotatably connected at its first end to the first wall portion at a fixed rotation point,
positioning the door restraining means onto a location of a mounting surface corresponding to a desired location for restraining the door into a secured position; and
anchoring the door restraining means onto the mounting surface at the desired location.

15. The method of claim 14, further comprising the steps of:
moving the door to the desired location, such that the base of the door is substantially covering the base body; and
rotating the rotatable arm portion about the fixed rotation point from a first position in which the door is unrestrained from movement, to a second position in which the door is restrained from movement, such that the door is secured between the rotatable arm portion and the second wall portion.

16. The method of claim 14, wherein the first wall portion and the second wall portion are substantially parallel to each other such that the second direction and the third direction is substantially one direction, the base portion is substantially perpendicular to both the first wall portion and the second wall portion such that the one direction is substantially perpendicular to the first direction, and wherein the first wall portion has a height, H₁, and the second wall portion has a height, H₂, such that H₂>H₁.

17. The method of claim 14, further comprising the step of rotating the rotatable arm portion about the fixed rotation point from the second position to the first position.

18. The method of claim 14, further comprising the steps of:
providing an extension portion defined between the first end of the rotatable arm portion and an opposite, second end for receiving a force to rotate the rotatable arm portion;
rotating the rotatable arm portion by engaging the extension portion.

19. The method of claim 14, further comprising the step of selecting the height of the first wall portion, H₁, and the height of the second wall portion, H₂, such that H₁<H_{D}<H₂, where H_{D} is the separation distance between the flat mounting surface and a base of the door.
